(19) United States
(12) Patent Application Publication
(10) Pub. No.: US 2020/0049105 A1
(43) Pub. Date: Feb. 13, 2020

(54) Socket Ignition Connector For Model Rockets

(71) Applicants: John Jerome Kusnierek, Springfield, OH (US); Jeffrey Richard DeWispelaere, Elk River, MN (US)

(72) Inventors: John Jerome Kusnierek, Springfield, OH (US); Jeffrey Richard DeWispelaere, Elk River, MN (US)

(21) Appl. No.: 16/101,494

(22) Filed: Aug. 12, 2018

(51) Int. Cl. F02K 9/95

(52) U.S. Cl. CPC F02K 9/95

(57) ABSTRACT

One embodiment of an application of micro-electronic socket pin connectors to model rocketry for the purpose of ignition of single or clustered solid model rocket motors. A socket based model rocket ignition connector is created by utilizing an appropriately sized low insertion force machine pin socket connector with electrical leads and potting such that model rocket igniter wires are simply placed into the sockets by hand pressure and sufficiently retained place by the functionality of the machine pin socket. The advantages of this embodiment include elimination of shorting failure modes, long service life, high success rate in clustered model rocket engines and being particularly helpful in educational settings with first time users. Other embodiments are described and shown.

### TECHNICAL FIELD

Model Rockets and Pyrotechnics—Igniter wire connector

### BACKGROUND

### Prior Art

US Patents

| Pat. No. | Kind Code | Issue Date | Patentee |
|---|---|---|---|
| 8,029,326 | A | 2011 Oct. 4 | Rossman |
| 5,410,966 | A | 1992 May 2 | Dorffler |
| 4,355,577 | A | 1982 Oct. 26 | Ady |
| 5,123,355 | A | 1992 Jun. 23 | Hans |
| 3,422,763 | A | 1969 Jan. 21 | Wait |
| 336,355 | A | 1968 Jan. 16 | Estes |
| 6,431,070 | A | 2002 Sep. 13 | La Mura |
| 5,342,225 | A | 1994 Aug. 30 | Farr |
| 6,347,946 | A | 2002 Feb. 19 | Trobough |

| | | |
|---|---|---|
| US Application Pub 0,327,240 | 2013 Dec. 12 | Guerra |

In the flight of model rockets, a pyrotechnic igniter is commonly used which consists of an electrically resistive round wire with a small area placed in the center of the wire length which is coated with a flammable pyrotechnic compound. In literature, this arrangement is also commonly referred to as an electric match, an electric fuse, or a two-wire ignitor. In all cases, the igniter is placed into the solid rocket motor through the open rocket nozzle with the flammable pyrotechnic compound in proximity to the propellant contained within the motor. The igniter must be physically held in the correct position and usually some type of retention mechanism such as adhesive tape, a paper plug, or a plastic plug is used at the point where the ignitor passes through the rocket motor nozzle to hold the igniter in position inside the rocket. In order for the ignition function to be achieved, an electric circuit is formed in which electric current flows from an electric current source into one of two igniter wires that are exiting the nozzle and out of the other wire forming an electric circuit. This current causes the wire, which may be nichrome, to heat up to the point that the flammable pyrotechnic compound ignites and in turn ignites the solid motor propellant. The igniter is largely consumed in this process, but any remnants are expelled out of the nozzle by the force of the solid rocket motor gas flow.

A critical aspect to this ignition process is how the electric current source is connected to each of the two leads of the igniter wire. Typically, electrically conductive wires from the electric source have spring loaded clamps of a suitable size that are squeezed by hand to open them up and then placed to cause them to clamp down on an igniter wire when the hand pressure is released. The approach of spring loaded clamps has been in use for decades in model rocketry and remains in use today. Model rocket ignition systems using spring loaded clamps is clearly described in U.S. Pat. No. 336,355 Estes in 1968 and U.S. Pat. No. 5,410,966 Dorffler in 1992. These spring loaded clamps are often commonly called micro-clips or sometimes alligator clips in model rocket flight operations.

Thus a single solid rocket motor will require two micro-clips to attach to the two igniter leads. For those model rockets with more than one engine, two micro-clips are required for each solid rocket motor. The person attaching the leads needs to attach both leads individually and normally this is done sequentially. The individual skill required to successfully do this is demanding and thus for example, educators in a class room setting can experience issues with youths understanding and successfully performing the operation of attaching the micro clips to the igniter wires.

While micro-clips are commonly used in this application for model rocketry, they have a number of serious disadvantages. The first of these disadvantages is that the micro clips and the igniter wires they attach to are typically not electrically insulated and are in close proximity to each other. The two igniter leads are typically approximately 10 mm apart and provide numerous opportunities to electrically short out the ignition circuit. This shorting can occur if the body of one of the micro clips touches the body of the other micro clip, or touches the other igniter wire, or the igniter wires themselves touch each other before the portion of the igniter wire with the flammable compound. The risk of shorting the ignition electrical circuit is substantially increased in the case where a model rocket uses more than one solid rocket motor. This type of model rocket design is usually referred to as having a cluster of solid rocket motors. These motors may be spaced apart in the model rocket, but are more frequently directly adjacent to each other. Thus for example, in the case of a model rocket with three solid rocket motors, the potential number of short circuits is nine and this fact causes a high risk of short circuit and failure when using micro clips. Some model rockets use many more than three clustered solid rocket motors and so the risk of short circuit failures becomes even larger.

A second disadvantage to the use of micro-clips in model rocketry is that upon successful ignition, the solid rocket motor exhaust impinges upon the micro-clip. The solid rocket motor exhaust consists of hot combustion gases with chemically reactive components and high velocity particles. This solid rocket motor exhaust causes a non-conductive coating to be deposited onto the micro-clips. With each successive ignition, the exhaust deposits become thicker and within a few launches can causes loss of conductivity from the micro-clip to the igniter wire to the point that misfires occur. For single engine model rockets, this most often results in a safety stand-down for a period of time and then installation of a new igniter, however, in the case of a cluster model rocket design this most often results in a failed flight due to some engines igniting and some engines not igniting causing the rocket to veer into the ground and be destroyed.

A third disadvantage is that after multiple uses the rotational joint in the micro-clip develops friction from the same solid rocket exhaust contamination. This can greatly limit the amount of pressure that the micro-clip can apply to the igniter wire and lead to the micro-clip not clamping tightly enough to create an electrical path or falling off prior to attempted ignition.

A fourth disadvantage is that over the course of several months, the micro-clip corrodes from the exhaust deposits even after only one single successful ignition. Thus both calendar shelf-life after first use and service life in terms of the number of launches are limited with micro-clips.

The embodiment of the socket ignition connector is primarily applicable to round wire-based ignitors used in model rocketry or pyrotechnics and may not have application to other forms of ignitors. For example, it is not applicable to the non-wire-based ignitor in U.S. Pat. No. 5,123,355 by Hans in which the construction of the ignitor is completely changed. Hans changes the conductive part of the ignitor to two electrically conductive thin copper foil strips that are bonded to each side of a thin electrical insulator. The electrical current flows into one conductive strip to the pyrotechnic compound and then out through the other conductive strip. Hans' patent further describes a unique clamp that fastens on to one end of the ignitor and provides suitable electrical conductivity to each of the electrically conductive strips. Still further solutions in pyrotechnic ignition utilize a completely different ignitor arrangement for pyrotechnic displays and are unsuitable for model rocketry such as U.S. Pat. No. 6,431,070 by LaMura, U.S. Pat. No. 5,342,225 by Farr or, US Application Pub 0,327,240 by Guerra.

The new embodiment contained in this document is applicable to round wire based solid rocket motor igniters in model rocketry usage. This said embodiment has a high yield success rate for those skilled in the art and is a significant advantage for those less skilled.

From initial test data on 20 socket ignition connectors of this type in over 100 ignitions of up to 20 clustered engines, a 100% ignition success rate was achieved. Additionally, connector systems of this type were re-used up to 30 times without misfire or degradation across months of usage. In usage with clustered solid rocket motors, significant advantages in ignition reliability occur and the practical limit to the number of clustered engines ranges up to more than 50. Additionally, as an improvement in educational settings using model rocketry, this connector system offers an increased an educational experience through ease of use, increased reliability, and increased safety.

### SUMMARY

In accordance with one embodiment, the application of a low insertion force two position machine pin socket provides a new ignitor connector system for use in model rocketry in which an electric source is connected to the igniter wire in a highly reliable manner and easy to use manner while achieving significant shelf life after first use and with significant service life.

### ADVANTAGES

Accordingly several advantages of one or more aspects are as follows; to provide a means to electrically connect an electrical source to a model rocket igniter that significantly reduces the risk of an unsuccessful ignition due to electrical shorting, insufficient electrical connectivity, or physically falling away from the igniter wire that is applicable to most model rocketry solid rocket motor igniters and especially with those model rockets with more than one motor. Other advantages of one or more aspects will be apparent from a consideration of drawings and ensuing description.

### BRIEF DESCRIPTION OF THE DRAWINGS

FIG. 1 depicts a typical model rocketry igniter using a resistive wire

FIG. 2 depicts a conductive compression clamp commonly called a micro-clip

FIG. 3 shows the prior art application of micro-clips for model rocketry

FIG. 4 depicts a two position Low Insertion Force version of a type of electronics connector commonly called a machine socket connector, or a machine pin Integrated Circuit socket connector, or a Single Inline Package socket connector

FIG. 5 shows the application embodiment of Low Insertion Force connector, wires, and potting compound for Model Rocketry ignitors

FIG. 6 shows how the application embodiment is used with a Model Rocketry ignitor

FIG. 7 shows the usage of the application embodiment with model rocket motor, model rocket igniter, electrical power system, and circuitry

FIG. 8 depicts an example of the prior art that provides simultaneous ignition in model rockets with more than one engine in a cluster

FIG. 9 shows an example of the application embodiment that provides simultaneous ignition in model rockets with more than one engine in a cluster

### DETAILED DESCRIPTION

### First Embodiment

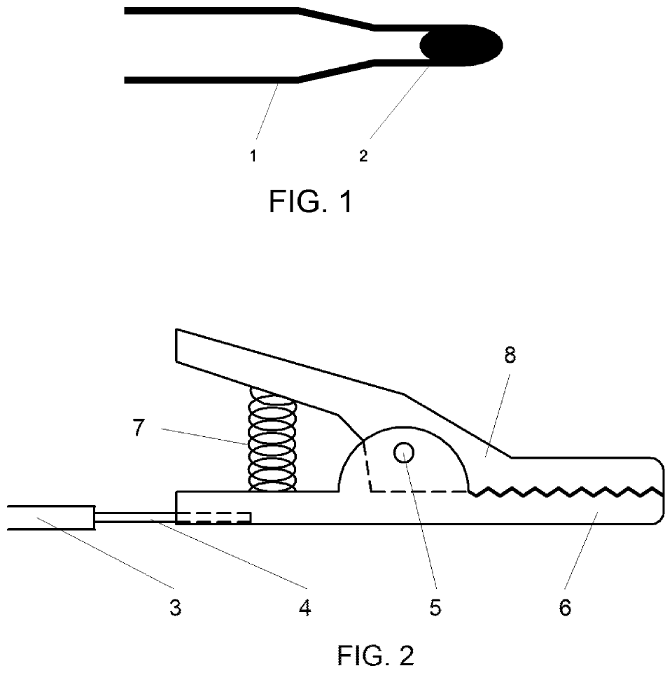

As shown in FIG. 1, a typical model rocketry igniter has a resistive wire (1) of appropriate diameter such that when electrical current flows through it, heating occurs to the point that a pyrotechnic compound (2) ignites in flame. This flame then ignites the solid rocket motor fuel which is in proximity to the pyrotechnic compound. Prior art most often uses a conductive compression clamp commonly called a micro-clip as shown in FIG. 2 to achieve an electrical contact with the two ends of the igniter wire. As shown in FIG. 2, the details of this prior art typically include an upper jaw (8) and a lower jaw (6) which pivot about a joint (5). The jaws are opened by putting finger pressure on the non-clamping end of the jaws. An igniter wire end is placed between the two jaws while a spring (7) places pressure on the opposite end of the jaws to place a clamping pressure on the igniter wire thus holding the wire between the jaws of the micro clip. Electrical current is provided through an electrically conductive wire (3) which is conductively attached (4) to the lower jaw of the micro-clip (6). For ignition, current flows through the wire then the micro-clip jaws, then through the contact point where the jaws clamp the igniter wire and then through the length of the igniter wire. Two micro-clips are required, one for each end of the igniter wire and so two clamps per motor are required.

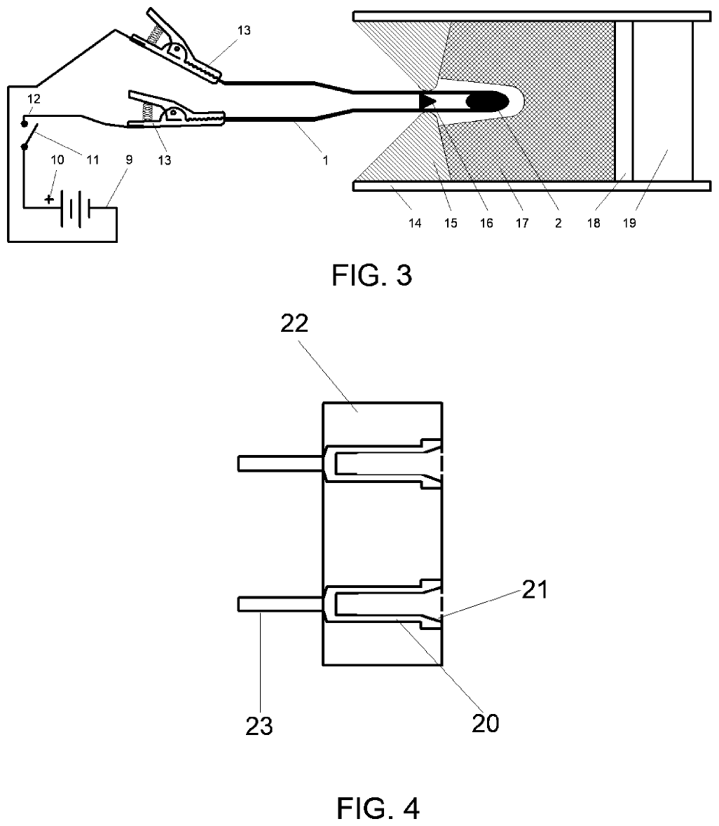

The prior art application of micro-clips for model rocketry is shown in FIG. 3. An electromotive source such as a battery (10) is attached to an electrical circuit with a switch (11) and positive wire (12) connecting to one mirco-clip (13) while the other micro-clip connects to the negative wire (9) of the battery. The typical solid model rocketry motor consists of a pressure vessel case (14), a nozzle (15), propellant (17), a combustible delay compound (18), and an ejection charge (19). For ignition and flight, the igniter wire (1) and pyrotechnic compound (2) are positioned by hand inside of the rocket motor in proximity to the propellant (17) and then a consumable plug (16) is pressured into the nozzle to hold the igniter in place in the solid rocket motor. The jaws of first one and then the other micro-clips (13) are opened, then placed over the igniter wire (1) while the micro-clips jaws are then allowed to clamp down on the igniter wire (1).

The successful use of the micro-clips in the model rocketry application depends on several simultaneous functional needs which include no-shorting between the micro-clips, sufficient clamping pressure on the igniter wire, sufficient electrical conductivity at the contact point between the jaw and igniter wire, and avoidance of electrical contact between the igniter wires. There are several ways in which the micro-clips can fail to meet these functional needs.

First of all, the micro-clips are typically not electrically insulated so any physical contact between the micro-clips is also an electrical short which causes an ignition failure. The igniter wires are spaced approximately 0.15″ to 0.5″ apart where the micro-clips clamp onto the wire, which is a close physical proximity that promotes shorting by contact to occur between the micro-clips. Additionally, the shorter the igniter wire path (1) is, the less energy is required to ignite the pyrotechnic compound (2) therefore accepted technique is that the micro-clips (13) are placed as close as possible to the motor nozzle (15). This however, increases the probability of shorting by the micro-clips touching each other.

Installation of the micro-clip involves clamping the micro-clip jaws onto the igniter wire (1) such that the micro-clips do not touch each other. This is done by carefully observing where the micro-clips are installed from multiple observation angles to see if they touch each other. But additionally, the micro-clips can physically move after installation. This can be caused by any or all of the following; shifting of the model rocket, movement of the launcher, wind, or weight or set of electrical wires (3), (9), and (12). Further, the micro-clips clamping action provides very little objection to rotating torque such as the electrical wires (3), (9), and (12) may provide and hence the micro-clips are largely free to rotate about the axis of the igniter wire (1). This action can cause the micro-clips to rotate such that they electrically contact one another and short out.

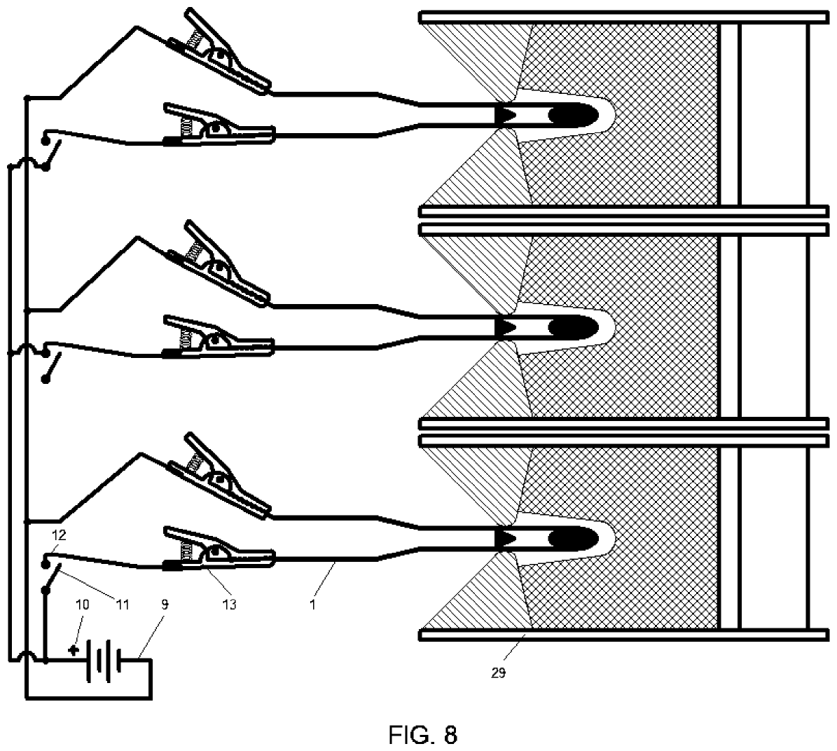

In the case of model rockets with more than one motor in a cluster of engines as shown in FIG. 8 with three motors (29), the disadvantages of micro-clips compound. For example, with one engine there is one shorting path while with three engines, there are now nine. These shorting paths remain in close physical proximity, but with all of the functional needs of a single engine.

An additional disadvantage occurs with this prior art in that, the solid rocket motor exhaust flows over the micro-clip as the rocket motor is ignited. This exhaust has constituents which both deposit on the micro-clip and promote corrosion. This affects the functionality of the micro-clip in subsequent usage in two ways. First of all the deposits have reduced electrical conductivity and effectively form an insulation layer which makes it difficult for electrical current to flow from the micro-clip (13) to the igniter wire (1). Second of all, the deposits and corrosion greatly increase the friction at pivot joint (5) and reduce the clamping pressure that the micro-clip jaws (5) and (6) place on the igniter wire. This has the effect of causing unsecure clamping which allows movement of the micro-clip which can enable touching the other micro-clip and cause an electrical short. This unsecure clamping can also cause the micro-clip to simply fall off of the igniter wire. Finally, in conjunction with the insulating deposits, the reduced clamping pressure can cause poor electrical conductivity from the micro-clip (13) to the igniter wire (1) and cause ignition failure.

The said new embodiment solves all of the disadvantages of prior art application to provide an ignition connector for model rocketry that is easy to use, eliminates shorting risks, maintains these advantages with clustered multiple motors, and can be used many times without degradation. The said embodiment is an application of a two position Low Insertion Force version of a type of electronics connector commonly called a machine socket connector, or a machine pin Integrated Circuit socket connector, or a Single Inline Package socket connector and is shown in cross-section in FIG. 4. This connector is manufactured in the micro-electronic component industry for use as a convenient way to temporarily or semi-permanently install electronic components such as fuses, resistors, shunts, and semi-conductors onto an electronic circuit board for example as shown in U.S. Pat. No. 6,347,946 by Trobough. The specific connector used in this embodiment has two electrically conductive open sockets (20) of precision size, shape, and socket features to hold micro-electronic devices by friction only with the said connector installed in micro-electronic circuits. The typical insertion force is approximately 70 grams while the withdrawal force is approximately 120 grams. Insertion of the igniter leads is assisted with the bevels (21) at the entrance to the socket (20). The two barrel sections are held in place by a solid structural non-conductive potting compound (22) which also isolates the two sockets electrically. Electrical current is provided through the two pins (23) which extend outside of the potting compound.

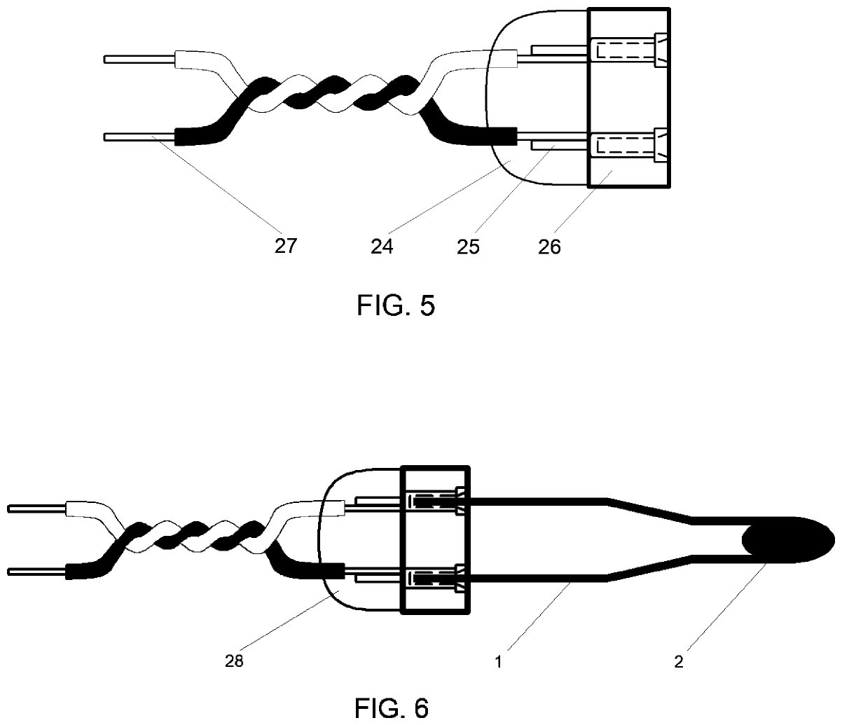

As shown in FIG. 5, the said embodiment then connects the two wires from the electrical source (27) to the connector (26) with solder (25) and then adds structurally solid potting compound (24) in an assembly.

As shown in FIG. 6, the socket connector assembly is used for model rocketry by inserting the igniter wire (1) into the connector assembly (28). The said embodiment includes selection of the appropriate diameter of socket (20), to enable the insertion of igniter wire (1) into the socket (20) by use of hand pressure to achieve a conductive contact with significant surface area that is secured by friction only and cannot short-out. The specific features of the socket are designed to hold conductors such as integrated circuit pins or a wire with friction, but still allow easy and insertion and removal of the igniter wire by hand. Unlike the prior art, it will be seen that there are no moving parts in the connector itself thereby increasing reliability. The embodiment includes the selection of appropriate placement of the sockets side-by-side to provide a physical geometry that allows easy installation of the two igniter wires either simultaneously or sequentially. Once installed, the connector itself maintains the separation of the igniter wires to prevent shorting. The collection of these features is ideal to connect with a round wire igniter used in model rocketry.

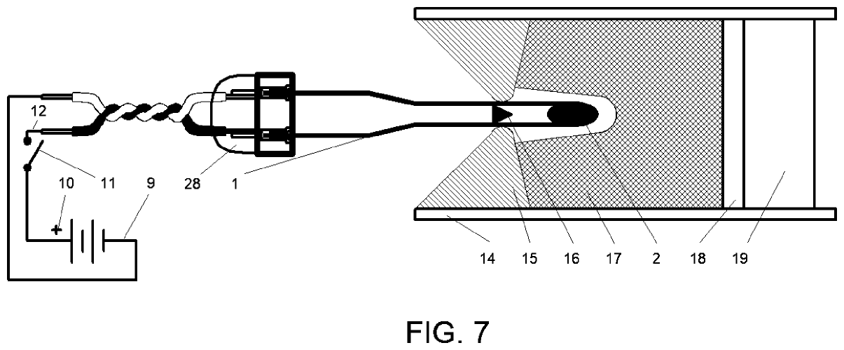

With usage of the said embodiment as shown in FIG. 7, it is easily seen that the system as a whole requires no changes to the model rocket motor, model rocket igniter, electrical power system, or circuitry with the sole exception of the addition of the said ignition connector embodiment as described. Additionally, the said ignition connector embodiment is easily adaptable to systems already in use with the prior art micro-clips by simply electrically splicing the said embodiment into the electrical circuit.

As an additional benefit of the said embodiment, the igniter wire placement inside the socket connector assembly effectively seals off the electrically conductive socket surfaces from the motor exhaust. This feature ensures that the conductive surfaces are not degraded by the motor exhaust deposits which enables reuse for subsequent ignitions.

After use, the ignitor wire is removed by simply pulling it out of the new embodiment connector by hand and the connector can be reused for multiple model rocket launches over the course of multiple years of calendar time.

To meet the need to provide simultaneous ignition in model rockets with more than one engine in a cluster, an example of three motors with prior art is shown in FIG. 8. In this case a group of six micro-clips (13) is required to ignite the three motors simultaneously. It will be easily seen that the close proximity of the micro-clips to one another provides increased opportunities for shorting and hence ignition failure.

Additionally, the electrical path length of igniter wire will vary if the micro-clips are not placed in the same relative place on each of the igniter wires. The electrical path length of the igniter wire then changes the circuit level resistance of the igniter wire. In practice, placing each of six the micro-clips in this example at the same relative point on the igniter wires (1) is difficult to achieve. Thus two micro-clips used to ignite an individual motor that are closer to the rocket nozzle than other micro-clips will cause a shorter electrical path of the igniter wire (1) which significantly lowers the resistance of the circuit for that motor. By simple electrical circuit analysis, the lower resistance will draw the most electrical current causing a quicker heating which will in-turn cause a quicker ignition for that motor.

Thus the motor with the shorter electrical path in the igniter caused by the prior art micro-clips ignites sooner than the other motors. This further complicates the ignition of the remaining motors in two different ways. First of all, the ignited motor causes high velocity exhaust gases to impinge on the micro-clips and electrical wires (9), (12), and (13) of the motors that have not ignited yet which in turn can cause movement of micro-clips such that they short to each other or fall off. Second of all, the ignited motor places a force on the model rocket which can cause the model rocket to translate or rotate which will cause movement of micro-clips which can then short to each other or fall off.

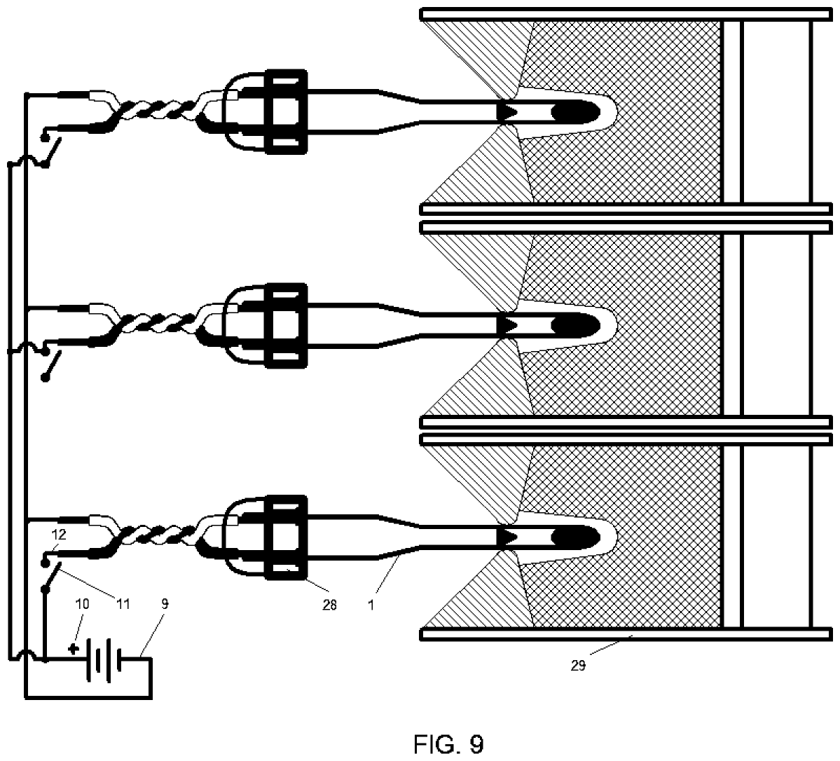

To meet the need to provide simultaneous ignition in model rockets with more than one engine in a cluster, an example of three motors with the new embodiment is shown in FIG. 9. In this case a group of three connectors of the new embodiment (28) is required to ignite the three motor simultaneously. It will be easily seen that the new embodiment connectors eliminates the possibility of shorting between connectors because they are electrically insulated.

Additionally, the same electrical path length for all of the igniter wires is automatically achieved by this new embodiment. Thus the two major shortcomings of the prior art are removed by the use of the new embodiment connector system. First the, probability of shorting between connectors is eliminated. Second the variation in relative electrical path length of the igniter wire between motors is greatly reduced.

### Additional Embodiments

There are various possibilities with regard to the said embodiment which may be adapted to and advantageous for the larger field of electrical pyrotechnic ignition. This includes such applications where an electrically resistive round wire is used for ignition purposes. Thus applications such as commercial fireworks, industrial single use pyrotechnic devices, and construction demolition may benefit from the said embodiment.

### Advantages

From the description above, a number of advantages of the socket ignition connector for model rockets become evident;

a) A high success rate connector apparatus for connecting the electrical power circuit to the igniter wire for use in model rocketry with solid rocket motors which dramatically reduces incidents of model rocket engine ignition failures.

b) A high success rate connector apparatus for connecting the electrical power circuit to the igniter wire for use in model rocketry with solid rocket motors which is is easy to use and is especially useful in educational settings.

c) A high success rate connector apparatus for connecting the electrical power circuit to the igniter wire for use in model rocketry with solid rocket motors which remains undegraded after each use and can be used multiple times over long spans of calendar time.

d) A high success rate connector apparatus for connecting the electrical power circuit to the igniter wire for use in model rocketry with solid rocket motors which has a high success rate in model rockets with clustered solid rocket motor engines and in particular enables numerical clustering beyond the current state of the art and is only limited by the practicalities of model rocket design.

### Conclusion, Ramifications, and Scope

Accordingly, the reader will see that the socket ignition connector for model rockets can be used to great advantage for solid rocket ignition in both single engine and clustered engine model rocket designs. In addition, said embodiment, because it does not rely on human skill to correctly achieve the electrical contact while avoiding shorting out the circuit is particularly attractive for an educational setting with first time users.

Furthermore, the socket ignition connector for model rockets has the additional advantages that;
It retains a high success rate through multiple uses and over a long calendar period.
It is completely compatible with existing igniter technology and electrical circuitry

Although the description above contains many specificities, these should not be construed as limiting the scope of the embodiments but as merely providing illustrations of some of several embodiments. For example, the socket ignition connector is also useful with appropriate resizing for as commercial fireworks, industrial single use pyrotechnic devices, and construction demolition. The scope of the embodiments should be determined by the appended claims and their legal equivalents, rather than by the examples given.

What is claimed is:

1) An application for low insertion force machine pin socket connectors in model rocketry for the electrical connection to round wire model rocket igniters to achieve reliable ignition of solid rocket motors comprising;
a. A low insertion force socket connector selected such that the diameter of the connector socket is optimized for model rocketry igniter wire diameter and
b. The assembly of a socket ignition connector for model rockets with electrical leads and insulating potting compound and
c. The connection of the electrical leads of the socket ignition connector for model rockets to the electrical power source and switch circuit and
d. The placement of the model rocket igniter leads into the sockets of the socket ignition connector for model rockets by using only hand pressure and
e. Electrical current is caused to pass through the new embodiment connector and through the igniter wire causing heating of the wire, ignition of the pyrotechnic igniter compound, and ignition of the solid rocket motor propellant and
f. The solid rocket motor exhaust gases are kept out of the conductive contact area of the new embodiment connector sockets by the presence of the igniter wires themselves and
g. After use, the ignitor wire is removed by simply pulling it out of the new embodiment connector by hand and the connector can be reused for multiple model rocket launches over the course of multiple years of calendar time.

2) For clustered model rocket engines;
a. A low insertion force socket connector selected such that the diameter of the connector socket is optimized for model rocketry igniter wire diameter and
b. The assembly of a socket ignition connector for model rockets with electrical leads and insulating potting compound and
c. The connection of the electrical leads of the socket ignition connector for model rockets to the electrical power source and switch circuit and
d. The model rocket igniter leads are placed into the sockets of the socket ignition connector for model rockets by using only hand pressure and
e. Electrical current is caused to pass through the new embodiment connectors and through the igniter wires causing heating of the wire, ignition of the pyrotechnic igniter compound, and ignition of more than one solid rocket motor and
f. The solid rocket motor exhaust gases are kept out of the conductive contact area of the new embodiment connector sockets by the presence of the igniter wires themselves and
g. After use, the ignitor wire is removed by simply pulling it out of the new embodiment connector by hand and the connector can be reused for multiple model rocket launches over the course of multiple years of calendar time.

3) An application for ignition socket connector to pyrotechnics using round wire electrical igniters;
a. The socket ignition connector for pyrotechnics has been selected such that the diameter of the connector socket is optimized for the round wire pyrotechnic igniter and
b. The socket ignition connector for pyrotechnics been assembled as a pyrotechnic igniter connector with electrical leads and insulating potting compound and
c. The electrical leads of the socket ignition connector for pyrotechnics are electrically connected to the electrical power source and switch circuit and
d. The pyrotechnic igniter leads are placed into the sockets of the socket ignition connector for pyrotechnics by using only hand pressure and
e. Electrical current is caused to pass through the new embodiment connector and through the igniter wire causing heating of the wire, ignition of the pyrotechnic igniter compound, and ignition of the pyrotechnic device and
f. The pyrotechnic device gases are kept out of the conductive contact area of new embodiment connector sockets by the presence of the igniter wires themselves and
g. After use, the ignitor wire is removed by simply pulling it out of the new embodiment connector by hand and the connector can be reused many times over the course of multiple years of calendar time.
